(19) United States
(12) Patent Application Publication
(10) Pub. No.: US 2005/0112324 A1
(43) Pub. Date: May 26, 2005

(54) Low gloss dry erasable surface

(76) Inventors: Barry M. Rosenbaum, Shaker Heights, OH (US); Raymond J. Weinert, Macedonia, OH (US); James E. Robbins, Twinsburg, OH (US); Michael R. Easterling, Reading, PA (US); Lawrence E. Hallenbeck, Binghamton, NY (US)

Correspondence Address: David G. Burleson;OMNOVA Solutions Inc., 175 Ghent Road, Fairlawn, OH, 44333, US

(21) Appl. No.: 10/719,665

(22) Filed: Nov. 21, 2003

(51) Int. Cl. B32B 1/00

(52) U.S. Cl. 428/141; 428/167

(57) ABSTRACT

A low gloss dry-erasable multilayer composite comprises a first layer having a dry-erasable outer surface and a second layer having a microroughened surface. Preferably, the second layer is microroughened by cure-induced surface wrinkling. The first layer preferably comprises a polymer comprising at least one pendant fluoroalkoxyalkyl functionality. Methods of making low gloss dry erasable multilayer composites are also provided. New dry-erasable coating compositions comprising certain amine resin crosslinking agents are also provided.

### FIELD OF INVENTION

The present invention relates to dry-erasable products such as marker boards, wallcoverings, projection screens and similar products. More specifically, the present invention relates to low-gloss dry erasable surfaces.

### BACKGROUND

Dry erasable products such as markerboards, wallcoverings, projection screens and the like are well known. Typically, such products take the form of a rigid or flexible substrate, which is provided with a dry-erasable surface layer. See, for example, U.S. Pat. No. 5,655,323; CA 2,322,815, CA 1144696 A1, WO09945979 WO00046270; and WO02/071148; the disclosures of which are incorporated herein by reference. The dry-erasable surface layer can be made from a fluorine-containing polymer such as polytetrafluoroethylene, polyethylene/tetrafluoroethylene, polyethylene/chlorotrifluoroethylene, polyvinyl fluoride and polyvinylidene fluoride or highly crosslinked melamine-type compounds.

Many of the better-performing dry-erasable surfaces also exhibit high gloss. To reduce this gloss, the outer surfaces of the products can be roughened through embossing or by introducing particulate deglossing agents such as silica and the like. Unfortunately, surface roughening introduces sites that can trap stains and inks and make them more difficult to remove. Thus, there is a tradeoff between dry-erase qualities, on the one hand, and surface glossiness on the other hand.

U.S. Pat. No. 5,361,164 discloses a projection screen which also is a dry erasable markerboard. The light reflecting writing surface of the combination projection screen and dry erasable markerboard preferably is white, off-white or light in color, and has a bi-directional lenticular embossed surface for increased and more accurate reflection of projected light, and a wider angle effective viewing area. The lenticular embossing is described at column 5, lines 23-30 as being provided by heat embossing using a roller with a bi-directional lenticular roller. In the preferred embodiment, this roller is described as having has approximately 90-100 lines criss-crossing per inch (i.e. 102,000 microns per line) with a 3 mil depth of pattern (i.e. 76.2 micron depth). Due to the dimensions of this embossed pattern, the pattern is clearly visible to the unaided eye of the observer.

### SUMMARY OF THE INVENTION

It has been found that dry-erasable surfaces can surprisingly be provided that exhibit excellent low-gloss properties. Such surfaces are provided as a multilayer composite comprising a first layer having a dry-erasable outer surface and a second layer having a microroughened surface.

By “microroughened surface” is meant that topographical features on the surface of the second layer are of small enough dimension so as to require an optic aid to the naked eye when viewed from any plane of view to determine its shape. In general, the topography of the surface of the second layer will comprise “positive features” (features projecting out of the body of the second layer) and “negative features” (features projecting into the body of the second layer). A microroughened surface topography will preferably have major positive features that are no more than about 200 microns apart, more typically 130 microns, as measured by microscopy. The average depth the variance in topography from the average tops of the positive features to the average bottom of the negative features will preferably be no more than about 10 microns, more preferably 7-8 microns, when measured by the same technique. By “dry-erasable outer surface” is meant a surface that when marked with dry erase markers, can be erased with a dry cloth or eraser.

Processes for making a low-gloss dry-erasable multilayer composite comprising a first layer and a second layer are also provided, comprising the steps of imparting a microroughened surface to the second layer and applying a first layer to the second layer so that the resulting multilayer composite has a dry-erasable outer surface.

The microroughened surface preferably is made by providing a second layer made from a radiation-curable material and using unique curing steps to form microwrinkles in the uppermost surface of the second layer.

Finally, the present invention also provides a new composition for forming dry-erasable surfaces, the composition comprising a polyester-based polyfluorooxetane crosslinked with an amine resin crosslinking agent in which the amine resin crosslinking agent is a co-etherified melamine formaldehyde resin reaction product of melamine and at least two different C₁ to C₁₀ alcohols.

### BRIEF DESCRIPTION OF THE DRAWING

The accompanying drawings, which are incorporated in and constitute a part of this application, illustrate several aspects of the invention and together with a description of the embodiments serve to explain the principles of the invention. A brief description of the drawings is as follows:

FIG. 1 is an edge view of a multilayer composite of the present invention.

FIG. 2 is an edge view of another embodiment of a multilayer composite of the present invention.

FIG. 3 is an edge view of a three layer embodiment of a composite of the present invention.

FIG. 4 is an edge view of an adhesive coated embodiment of a composite of the present invention.

FIG. 5 is an edge view of another adhesive coated embodiment of a composite of the present invention.

FIG. 6 is a photomicrograph of a multilayer composite of the present invention.

### DETAILED DESCRIPTION

An important dry-erasable product is dry-erasable wallcoverings, i.e., thin, flexible sheets of material which are intended to be glued or pasted onto walls in the same way as conventional vinyl wallcoverings. Another significant product is the dry-erasable white markerboard found in most schools and offices. Front and rear projection screens, such as illustrated in U.S. Pat. No. 5,655,323, and WO 02/071148 A2, as well as message and note boards such as shown in U.S. Pat. No. 5,361,164, are also available in the form of dry-erasable products. Decorated products having single, two or even multicolored printing, figures, geometric designs or pictures may also be rendered dry-erasable. Other products such as posters, clipboards, menus, papers, book covers, graffiti-resistant surfaces, tablecloths, etc. can also be made dry-erasable.

Although these products differ significantly from one another in terms of overall structure and configuration, they all include a substrate forming the basic structure of the product plus a surface layer attached directly or indirectly to the substrate for providing dry-erasable properties. By “indirect attachment” is meant that one or more additional layers such as a printed layer, an anchoring layer or the like are interposed between the substrate and dry-erasable surface layer. Since the present invention can be used to manufacture any type of dry-erasable product, any type of substrate which is or becomes known for use in making dry-erasable products can be used to make the dry-erasable products of this invention. Thus, rigid boards and other sheets can be used, for example, in making rigid markerboards, while flexible sheets such as cloth, paper, plastic (e.g. polyvinyl chloride, thermoplastic polyolefins such as polyethylene and polypropylene, polyethylene terephthalate, polybutylene terephthalate and other polyesters, ethylene-styrene copolymers, polycarbonates, and combinations thereof) sheets and webs and the like can be used for making flexible products such as dry-erasable wallcoverings and the like. Multi-layer sheets and composites, both rigid and flexible, can also be used, as desired.

These substrates can be used as is, i.e. without surface treatment, or they can be treated to enhance or change their surface properties before being further processed. Because the dry-erasable surface system of the present invention is normally translucent and preferably substantially transparent, a desired color and/or appearance can be imparted to the ultimate product by suitably coloring, printing, decorating or marking the substrate before the surface system is applied. For example, simulated wood grain patterns or other indicia can be developed in the ultimate product by printing the pattern or indicia on the substrate. The substrate can be uniformly colored, if desired, or printed for use for example in making marker boards and the like.

In addition to surface appearance, the physical and/or chemical properties of the substrate surfaces can also be modified, if desired. For example, suitable anchor layers can be coated or laminated onto the substrate to enhance adhesion of the inventive dry-erasable surface system. Other surface treatments such as etching, corona discharge, surface embossing and the like can also be employed.

As used herein, the term “copolymer” encompasses both oligomeric and polymeric materials, and encompasses polymers incorporating two or more monomers. As used herein, the term “monomer” means a relatively low molecular weight material (i.e., generally having a molecular weight less than about 500 Daltons) having one or more polymerizable groups. “Oligomer” means a relatively intermediate sized molecule incorporating two or more monomers and generally having a molecular weight of from about 500 up to about 10,000 Daltons. “Polymer” means a relatively large material comprising a substructure formed two or more monomeric, oligomeric, and/or polymeric constituents and generally having a molecular weight greater than about 10,000 Daltons.

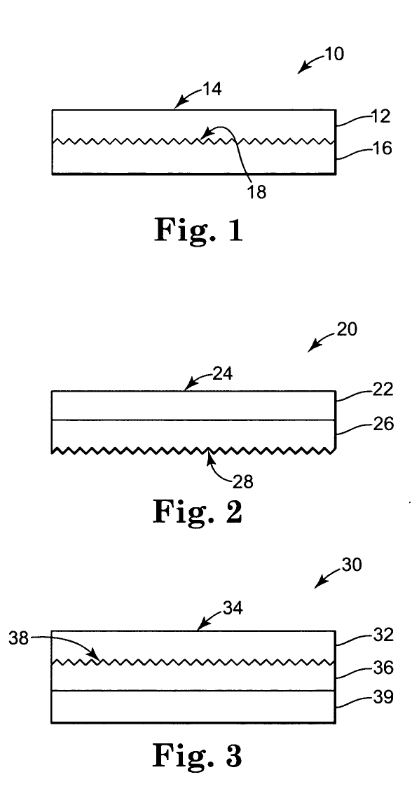

Turning now to the drawings (which are not to scale), wherein like numbers represent like parts, FIG. 1 is an edge view of a multilayer composite 10, comprising first layer 12 having a dry-erasable outer surface 14, and second layer 16 having a microroughened surface 18. First layer 12 is preferably conforms to the contours of microroughened surface 18 to provide full direct physical contact between first layer 12 and second layer 16.

First layer 12 is selected from materials are known which exhibit dry-erasable properties, and any such material can be used to form the first layer 12 of the inventive dry-erasable products. The materials of first layer 12 additionally are transparent or translucent, to allow incident light to at least partially pass through first layer 12 and be scattered by microroughened surface 18. Specific examples of such materials are fluoropolymers such as polytetrafluoroethylene, polyethylene/tetrafluoroethylene, polyethylene/chlorotrifluoroethylene, polyvinyl fluoride and polyvinylidene fluoride.

In a preferred embodiment of the invention, the first layer 12 of the inventive dry-erasable product comprises a polymer having at least one pendant fluoroalkoxyalkyl functionality. Preferably, the fluorinated alkyl groups are the same or different and, independently, on each repeat unit, preferably is a linear or branched fluorinated alkyl of 1 to about 20 carbon atoms, more preferably from about 1 to about 8 carbon atoms, and most preferably from about 1 to about 4 carbon atoms, with a minimum of 25%, 50%, 75%, 85%, 90%, or 95%, or 100% (perfluorinated), of the non-carbon atoms of the alkyl being fluorine atoms.

Preferably, the alkyl groups are the same or different and, independently, on each repeat unit, preferably is a linear or branched alkyl of 1 to about 20 carbon atoms, more preferably from about 1 to about 8 carbon atoms, more preferably from about 1 to about 4 carbon atoms, and most preferably is a methylene linking group.

Preferably, the fluoroalkyl portion of the pendant fluoroalkoxyalkyl functionality comprises from 1 to about 20 carbon atoms and the oxyalkyl portion of the fluoroalkoxyalkyl functionality comprises from 1 to about 4 carbon atoms. More preferably, the fluoroalkyl portion of the pendant fluoroalkoxyalkyl functionality comprises from 1 to about 8 carbon atoms and the oxyalkyl portion of the fluoroalkoxyalkyl functionality comprises 1 carbon atom.

Most preferably, the pendant fluorine-containing functionality is derived from a fluorooxetane. Preferably, this component is provided as a polyfluorooxetane polymer, blended or more preferably copolymerized with additional moieties to form copolymer, and particularly block copolymers having pendent fluorine substituted moieties. By “polyfluorooxetane” is meant oligomers and polymers that contain fluorine-containing groups pendant from an oxetane-containing backbone. By “polyalkyloxetane” is meant oligomers and polymers that contain alkyl-containing groups pendant from an oxetane-containing backbone. Polyfluorooxetanes are well-known in the art and described, for example, in U.S. Pat. No. 5,650,483; U.S. Pat. No. 5,654,450; U.S. Pat. No. 5,663,289; U.S. Pat. No. 5,668,251; U.S. Pat. No. 6,383,651 B1; U.S. Pat. No. 6,403,760; WO 01/00701 Al; WO 01/48051 Al; WO 02/34848 A1 and WO 02/04538 A2; the disclosures of which are incorporated herein by reference.

These polymers typically contain about 1 to 25 wt. %, more typically 2 to 10 wt. % of oxetane segments having pendant alkyl and/or fluorine-containing alkyl groups polymerized with other comonomers. Normally, the polyoxetane segments are incorporated via condensation polymerization into polymers such as polyesters, polyamides, polyurethanes and the like, but they may also copolymerize with acrylics and other addition polymers capable of bonding to the oxetane segments by a condensation reaction. These copolymers make good surface coatings for dry-erasable products, since they exhibit low surface energy, high hydrophobicity, and low coefficients of friction and, in some cases, improved abrasion resistance and stain resistance.

Polyoxetanes of special interest are those which are made by copolymerizing the fluoro-modified polyoxetanes with polyester-forming reactants as described, for example, in U.S. Pat. No. 6,423,418 B1 and U.S. Pat. No. 6,383,651 B1, the disclosures of which are also incorporated herein by reference. Such polymers typically include oxetane segments composed of 1 to 20 repeating oxetane monomers having pendant —CH₂—O—(CH₂)ₙR groups, where R is an Rf or alkyl group. When R is an Rf group the n is preferably an integer from 1 to 5, and more preferably from 1 to 3. The Rf or alkyl groups on each monomer is preferably, independently, a linear or branched alkyl group having 1 to 20 carbon atoms, more preferably 1 to 10 carbon atoms, and most preferably 3 to 7 carbon atoms. In the case where R is an Rf group, preferably at least 25%, more typically at least 50%, at least 75%, at least 85%, or even at least 95% of the H atoms in such alkyl groups are replaced by F. Optionally, some or all of the remaining H atoms on the Rf or alkyl groups can also be replaced by I, Br and/or Cl, if desired. Alternatively, the Rf groups can each independently be an oxaperfluorinated polyether having 1 to 6 carbon atoms. Also, additional oxirane or other unhindered ring structures such as tetrahydrofuran can be copolymerized with the fluoro- and alkyl- oxetane monomers, if desired.

Especially interesting polyfluorooxetanes are the amino-polyester resins which contain about 0.2 to 15, more typically about 0.5 to 10 wt. % “fox” groups, i.e. oxetane units having pendent —CH₂—O—(CH₂)ₙRf groups, and which are made by copolymerizing oxetane segments containing 1 to 50 repeating fox units with polybasic acids and polyhydric alcohols to form hydroxyl-terminated polyesters and then crosslinking these hydroxyl-terminated polyesters with amino resin cross-linking agents. See, U.S. Pat. No. 6,423,418 B1 and U.S. Pat. No. 6,383,651 B1, mentioned above.

Alternatively the polyfluorooxetanes are the amino-polyester resins which contain about 0.2 to 15, more typically about 0.5 to 10 wt. % “ROX” groups, i.e. oxetane units having pendent —CH₂—O—(CH₂)ₙR groups, and which are made by copolymerizing oxetane segments containing 1 to 50 repeating fox units with polybasic acids and polyhydric alcohols to form hydroxyl-terminated polyesters and then crosslinking these hydroxyl-terminated polyesters with amino resin cross-linking agents.

These polyfluorooxetane modified polyester coatings are typically prepared in situ by applying a solution of a hydroxyl-terminated polyester containing copolymerized oxetane segments, an amino resin cross-linking agent and a curing catalyst such as p-toluene sulfonic acid in a suitable solvent or solvent mixture containing such constituents as methyl ethyl ketone, n-propyl acetate, tetrahydrofuran, water, alcohols or the like to the substrate and then heating the applied coating to an elevated temperature such as 150, 200, 250 or even 400° F. to evaporate the solvent and effect curing, i.e., crosslinking of the polyester with the amino resin crosslinking agent. The hydroxyl-terminated oxetane-containing polyester, in turn, is typically prepared by reacting the pre-formed, hydroxyl-terminated oxetane segments with an excess of the polybasic acid to form acid-terminated oxetane segments and then condensation polymerizing these segments with additional amounts of polybasic acids, and additional polyhydric alcohols, if desired.

As described in the above-noted patents, a wide variety of different polyhydric alcohols, polybasic acids and amino resin cross-linking agents can be used to make these polyoxetane modified copolymers or oligomers. Especially interesting are aliphatic carboxylic acids having from about 3 to 10 carbon atoms, aromatic carboxylic acids having about 10 to 30 carbon atoms and polyhydric alcohols having form about 2 to 20 carbon atoms and about 2 to 5 hydroxyl groups. Polymeric polyols having number average molecular weights from 100 to 10,000 are also interesting. All of these materials can be used in making the dry erase surface coatings of the present invention. Mixtures of different polyhydric alcohols, polybasic acids and cross-linking agents can also be used, as can oxetane segments with different pendant —CH₂—O—(CH₂)ₙRf groups.

In addition, as further described in U.S. Pat. No. 6,383,651 B1, these hydroxyl-terminated oxetane segments can be coupled to the polyester blocks or polyester-forming components of these polyfluorooxetanes via urethane linkages derived from the reaction of isocyanate groups from a di or polyisocyanate compound, if desired. In this case, any di or polyisocyanate compound can be used having a formula of X—(CNO)_{y} where y is an integer of 2 or more and X is an aliphatic group of 4 to 100 carbon atoms, an aromatic group of 6 to 20 carbon atoms, or a combination of alkyl and aromatic groups or alkyl-substituted aromatic or aromatic-substituted alkyl groups of 7 to 30 carbon atoms, or mixtures thereof. Preferred urethane compounds are 4,4′-methylene diphenyl diisocyanate, (MDI), liquid polymeric MDI, toluene dilsocyanate, 1,6-hexane diisocyanate, isophorone diisocyanate, trimethylhexane diisocyanate and so forth.

A particularly interesting polyfluorooxetane surface coating for use as first layer 12 in the present invention is composed of the amine-crosslinked polyester-based polyfluorooxetanes described above, with or without urethane linkages, in which the amine resin crosslinker is a highly-etherified, low-molecular weight, co-etherified melamine formaldehyde resin.

In earlier disclosures, such as the above-noted U.S. Pat. No. 6,423,418 BI and U.S. Pat. No. 6,383,651 B1, the amine resin crosslinker typically used is a liquid hexamethoxymethyl melamine (“HMMM”) (e.g. the crosslinking material is a tri-adduct of an amine with formaldehyde), which is a reaction product of melamine and methanol only. Such products typically have an equivalent weight of 75-185 and an average degree of polymerization of ≈1.4. This does not preclude the use of other melamine or urethane crosslinking adduct with different molecular weights or functionality.

Finally, a wide variety of different adjuncts can be included in the dry-erasable surface layers of the present invention such as viscosity modifiers, antioxidants, antiozonants, processing aids, pigments, fillers, ultraviolet light absorbers, adhesion promoters, emulsifiers, dispersants, and the like. In addition, conventional flattening agents such as hydrocarbon, fluoropolymer, silicone waxes and polymers, hollow spheres, silicas, aluminum oxide, alpha silicon carbide, etc., can also be added. Care should be taken, however, to avoid excessive amounts of these adjuncts, especially those which impart too much surface roughness to the surface layer or increase the surface energy of the surface layer to any large extent, so as not to adversely affect the dry-erasable properties thereof to any significant degree.

The first layer 12 is applied to second layer 16, whose microroughened surface 18 exhibits extremely low gloss as a result of a microroughened surface topography. Gloss is measured by any appropriate method in the art, preferably by using a Gardner Gloss Meter in accordance with ASTM D523 or B499. By “extremely low gloss” is meant a surface gloss rating of about 10 or less when measured at angle of incidence of 60° with a Gardner Gloss Meter in accordance with ASTM D523. Second layer 16 preferably has sufficient microroughened surface topography so that the resulting second layer prior to application of first layer 12 exhibits a surface gloss rating of 5 or less (i.e., “dead flat”), and more preferably has a surface gloss of 4 or less, and most preferably 3 or less. After application of first layer 12 to second layer 16, the resulting dry erase composite 10 exhibits a low gloss appearance, preferably less than 40, and more preferably less than 25 when measured at angle of incidence of 60° with a Gardner Gloss Meter in accordance with ASTM D523.

In one embodiment of the present invention, microroughened surface 18 comprises a random distribution of ridges and valleys. Preferably, the appearance of the microroughened surface, when examined under optical enhancement, is that of surface wrinkles. Alternatively, microroughened surface 18 comprises an ordered pattern of positive features and/or negative features. In this embodiment, a preferred microroughened surface 18 comprises an ordered pattern of ridges and valleys. Alternatively, microroughened surface 18 comprises an ordered pattern of feature shapes including, but are not limited to, those selected from the group consisting of hemispheres, prisms (such as square prisms, rectangular prisms, cylindrical prisms and other similar polygonal features), pyramids, ellipses, and grooves. Positive or negative features can be employed, i.e. convex hemispheres or concave hemispheres, respectively. The preferred shapes include those selected from the group consisting of hemispheres, pyramids (such as cube corners, tetrahedra, etc.), and “V” grooves. Although the exemplified features are non-truncated in nature, it is believed that truncated features will also be suitable in the composites of the present invention. The features of the microroughened surface 18 may be systematically or randomly generated.

Second layer 16 preferably is a polymer film layer, such as a film made from vinyl chlorides, urethanes, polyesters, polyethers, polycarbonates or polyolefin composition polymers such as acrylate and/or methacrylate jointly referred to as “(meth)acrylate”) copolymers, and hybrids of one or more of these polymers. More preferably, second layer 16 comprises a radiation curable polymeric material as described in further detail below. Second layer 16 preferably is transparent or translucent.

Preferably, the microroughened features are uniformly distributed over all of microroughened surface 18, so that the overall surface of composite 10 appears to have a uniform gloss. Alternatively, portions of composite 10 may have a reduced amount of microroughened surface, so that glossy portions are apparent to the observer. In a preferred embodiment of this aspect of the invention, the portions of microroughened area may be located so that either or both of the glossy appearing section or the non-glossy appearing section provide a pattern discernable to the observer. In a particularly preferred aspect of this embodiment, either or both of the glossy appearing section or the non-glossy appearing section provide a pattern communicating an image or message to the observer, such as a corporate logo or the like.

FIG. 2 is an edge view of an alternative multilayer composite 20, comprising first layer 22 having a dry-erasable outer surface 24, and second layer 26 having a microroughened surface 28. Microroughened surface 28 is located on the opposite side of second layer 26 from first layer 22 in this embodiment. Second layer 26 in this embodiment is transparent or translucent to allow light to pass through second layer 26 and be scattered by microroughened surface 28, thereby providing a low gloss composite. Material selections for manufacture of various components of this embodiment are preferably selected from the same materials as corresponding layers of the embodiment of FIG. 1 above.

FIG. 3 is an edge view of an alternative multilayer composite 30, comprising first layer 32 having a dry-erasable outer surface 34, and second layer 36 having a microroughened surface 38. Substrate layer 39 is provided on the opposite side of second layer 36 from first layer 32. Substrate layer 39 may be any appropriate layer providing support or decorative properties to the composite 30. Substrate layer 39 preferably is a polymer film layer, such as a film made from vinyl chlorides, urethanes, polyesters, polyethers, polycarbonates or polyolefin composition polymers such as acrylate and/or methacrylate (jointly referred to as “(meth)acrylate”) copolymers, and hybrids of one or more of these polymers. Substrate layer 39 is laminated directly or with an intermediate tie layer (not shown) to second layer 36. Substrate layer 39 optionally may comprise additional backing components, and optionally may comprise decorative coloration such as printing. Additional material selections for manufacture of various components of this embodiment are preferably selected from the same materials as corresponding layers of the embodiment of FIG. 1 above.

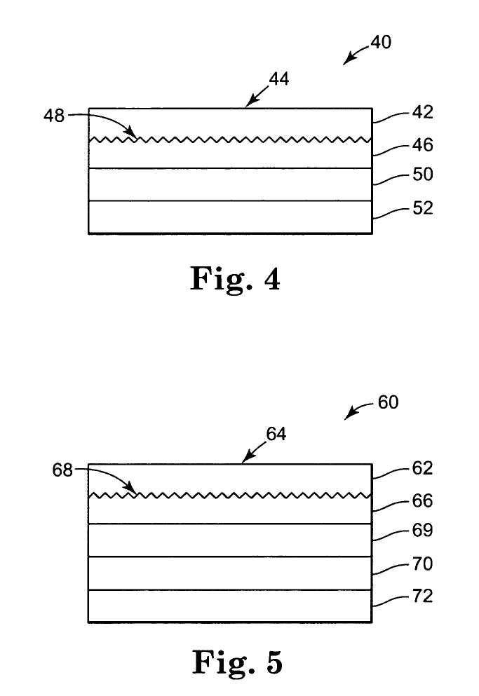

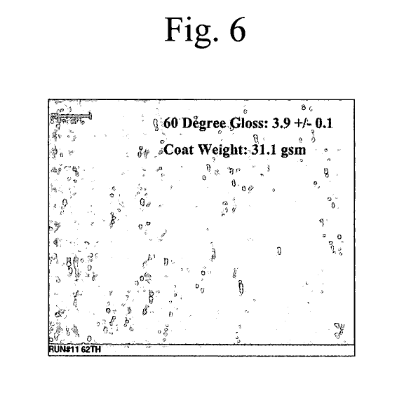

FIG. 4 is an edge view of an alternative multilayer composite 40, comprising first layer 42 having a dry-erasable outer surface 44, and second layer 46 having a microroughened surface 48. Adhesive layer 50 is additionally provided on the opposite side of second layer 46 from first layer 42 for adhesively fixing multilayer composite to an intended final substrate, such as a wallboard, a chalkboard, a wall or other preferably rigid structure. Adhesive layer 50 may be selected from any adhesive material suitable for the particular application, including water activated, heat set adhesives and pressure sensitive adhesives. Preferably, the adhesive is a pressure sensitive adhesive, and may be selected from removable, repositionable, and permanent adhesives such as are known in the art. Release liner 52 is optionally removably affixed to adhesive layer 50 to protect adhesive layer 50 from premature adhesion to unintended surfaces. Release liner 50 may be selected from any low surface energy layer, such as a film or coated paper such as are known in the art. Additional material selections for manufacture of various components of this embodiment are preferably selected from the same materials as corresponding layers of the embodiment of FIG. 1 above.

FIG. 5 is an edge view of an alternative multilayer composite 60, comprising first layer 62 having a dry-erasable outer surface 64, and second layer 66 having a microroughened surface 68. Substrate layer 69 is provided on the opposite side of second layer 66 from first layer 62. Adhesive layer 70 is additionally provided on the opposite side of substrate layer 69 from second layer 66 for adhesively fixing multilayer composite to an intended final substrate, such as a wallboard, a chalkboard, a wall or other preferably rigid structure. Release liner 72 is optionally removably affixed to adhesive layer 70 to protect adhesive layer 70 from premature adhesion to unintended surfaces. Additional material selections for manufacture of various components of this embodiment are preferably selected from the same materials as corresponding layers of the embodiment of FIG. 4 above.

Providing a second layer with an extremely low gloss, microroughened surface can be done in a variety of different ways. For example, particulate materials such as silica, alumina, calcium carbonate, calcium carbide, etc. having particle sizes on the order of 3 to 12 microns, preferably 3 to 6 microns can be incorporated into the second layer before, during or after it is applied to the substrate. In addition, the second layer or substrate can be microembossed, i.e. embossed with a calendar roll, textured cover sheet or other tool which will introduce indentations of the appropriate size.

Preferably, however, the second layer is formed by a surface wrinkling technique in which a layer of a radiation-curable material is applied to the substrate and then irradiated in a manner which causes the surface of the second layer to wrinkle. Surface wrinkling of radiation-curable materials is known. See, for example, Fried, GLOSS-REDUCTION MECHANISMS OF RADIATION CURE COATINGS, Radiation Curing, February 1982, pp. 19-25, 9(1), 19-25, RACUDO; ISSN: 0146-4604.

In this technique, a material capable of radiation curing is subjected to a multi-step curing procedure in which, prior to final cure, the material is irradiated under conditions which selectively cure only the uppermost surface of the material. As a result, the selectively-cured uppermost surface hardens and shrinks relative to the remainder of the material. This, in turn, causes roughness due to surface shrinkage and/or microcracks and/or other fissures to form in the material's surface, this roughness, microcracks and/or fissures being referred to herein as “wrinkles.” Other curing techniques may be used to obtain a microwrinkled surface by controlled or sequential curing methods. In accordance with the present invention, it has been found that these cure-induced wrinkles provide a preferred type of microroughened, extremely low gloss surface topography to produce low gloss dry-erasable products in accordance with the present invention.

As explained in the above disclosures, cure-induced surface wrinkling can be carried out in a variety of different ways. For example, the surface of the radiation-curable material can be at least partially cured with UV light (about 240 to about 450 nm in wavelength); with “germicidal” light (about 100 to about 300 nm in wave length with inert atmosphere); and/or with heat (e.g. about 100 to about 140° F., followed by surface curing with “germicidal” light (about 100 to 300 nm in wave length) to develop the desired wrinkling. After the desired wrinkling is obtained, the entire thickness of the coating is cured by application of heat and/or additional UV light.

Irradiation can also be carried out using other forms of radiant energy, such as electron beam radiation particularly for bulk cure. All of these techniques can be employed in accordance with the present invention to provide the desired microroughened surface topography.

In the embodiment where the microroughened surface is provided by cure-induced surface wrinkling, essentially any type of radiation-curable material can be used to form the second layer of the present invention. Such materials typically include radiation-curable polymers, which are typically polymers, prepolymers, oligomers, monomers and mixtures thereof which are capable of further polymerization and/or cross-linking as well as catalysts and/or initiators which are capable of triggering this polymerization and/or cross-linking in response to applied radiation, typically UV light and/or electron beams. Preferred radiation-curable materials are also solvent-resistant, i.e., they resist dissolution or degradation by the solvent used for applying the dry-erasable surface layer whereby the desired wrinkled surface topography of the second layer is substantially maintained.

Specific examples of the radiation-curable moieties that can be used to form the second layers of the present invention are acrylate, methacrylate, or allylic monomers, vinyl aromatic monomers of 8 to 12 carbon atoms, N-vinyl pyrrolidone, epoxy acrylate oligomers, and urethane acrylate oligomers.

A particularly interesting class of radiation-curable polymers for use in the present invention are the radiation-crosslinkable polyurethane acrylate copolymers. The urethane component of these polymers is formed from a polyether- and/or polyester-based diol reacted with an isocyanate, preferably a polyisocyanate which can be aromatic or aliphatic. Any of the known diisocyanates can be used and illustrative thereof one can mention 2,4-(or 2,6-)toluene diisocyanate; 3-isocyanatomethyl-3,5,5-trimethylcyclohexyl isocyanate; diphenylmethane diisocyanate; 2,2,4-trimethylhexamethylene diisocyanate; xylene diisocyanates; hexamethylene diisocyanate; dicyclohexyl-4,4′ methane diisocyanate; para,para′-4,4′-methylenebis-(phenyl isocyanate) (MDI); phenylene-1,4-diisocyanate (PPDI); 1,5-naphthalene diisocyanate (NDI); isophorone diisocyanate (IPDI); hexamethylene diisocyanate (HDI); 1,6-diisocyanato-2,2,4,4-tetramethyl hexane (TMDI); as well as any of the other known organic isocyanates. The urethane is crosslinked with a crosslinking agent which is preferably an acrylate component, which can comprise a number of different acrylates. Both the urethane component and the acrylate component are well known in the art.

The acrylates utilized can be mono-, di-, or polyacrylates, with the polyfunctional acrylates being preferred. Examples of suitable acrylates include, but are not limited to, 2-ethylhexyl acrylate, hexamethylene diacrylate, glycidyl acrylate, ethylene glycol diacrylate, tripropylene glycol diacrylate, neopentyl glycol diacrylate, 2-methoxyethyl acrylate, and 2-phenoxyethyl acrylate. The surface coating composition has generally from about 0.1 to about 200 parts, and preferably from about 0.2 to about 100 parts of acrylate component per 100 parts by weight of the urethane acrylate oligomeric component.

The second layer composition can contain suitable or sufficient amounts of additives, initiators, fillers, etc.

One suitable second layer composition is commercially available from PPG of Pittsburgh, Pennsylvania as Durethane® UV Low Gloss N. It is believed that Durethane UV Low Gloss N is a polyacrylic containing deglossing agents.

The second layer is preferably applied to the substrate surface in an amount generally from about 8 to about 40 grams per square meter, desirably from about 12 to about 35 grams per square meter, and preferably from about 15 to about 30 grams per square meter (dry weight). Amounts lower than about 8 grams per square meter can also be used, provided that the desired wrinkled effect can still be achieved. Amounts greater than 40 grams per square meter can also be used, although there is little if any advantage in doing so. Also, effecting complete cure of a second layer throughout its thickness can become difficult if the second layer is too thick.

The second layer can be applied to the substrate, or to an under layer on the substrate, by any suitable method such as spraying, brushing, rod, cascade, curtain coating and rotogravure. Suitable solvents can also be included in the composition, if desired.

The first layer may be applied to the second layer as a sheet in a lamination process in any manner suitable for fabricating such lamination products. When the layers are discrete sheets or films prior to lamination, the first layer may optionally be adhered to the second layer by an adhesive. Preferably, such an adhesive is optically clear and additionally is capable of flowing to fill all gaps between the first layer and second layer due to different surface topographies of the two film materials. Preferably, the first layer is applied to the second layer as a coating composition, with subsequent curing of the first layer. Application of the first layer to the second layer in a coating operation allows superior conformation of the first layer to the second layer, particularly when the first layer is in direct physical contact with the microroughened surface of the second layer. Preferably, the coating composition used to provide the first layer is of a viscosity so that the coating is self leveling during application of the composition to the second layer, thereby providing both good conformation to the surface of the second layer and a uniform outer surface. A uniform outer surface is particularly desirable in providing few or no interstices in which dry erase marker material may become trapped.

In another aspect of the present invention, it has been further found that exceptional dry-erasable outer surfaces may formed using amine-crosslinked polyester-based polyfluorooxetane surface coatings by using melamine formaldehyde crosslinking resins which are co-etherified products, i.e., reaction products of melamine and at least two different C₁ to C₁₀ alcohols. Preferably, at least one of these alcohols is methanol, while the other alcohol is a C₂ to C₆ alcohol. More preferably at least one of these alcohols is methanol, while the other alcohol is n-butanol, each of which is present in the surface coating composition in an amount of at least 5 mol. %, and more preferably at least 10 mol. %. In addition, the crosslinking moiety is preferred to be largely monomeric in nature. Preferably, the crosslinking moiety comprises less than 10% compounds having repeating units (e.g. dimers and trimers). A preferred such crosslinker is a melamine crosslinking agent designated Resimene® CE-7103 crosslinker, commercially available from UCB Surface Specialties Inc.

While not being bound by theory, it is believed that the monomeric nature of the melamine ring allows for a more uniform molecular weight build and results in what would be considered to be the construction of a more uniform polymer matrix. The coating also exhibits improved flow and leveling ability of the lower viscosity coating resin. In theory, the crosslinker as described herein provides a unique cure profile that allows more mobility of surface active functionality in the cure process of the dry erase coating, thereby allowing the selective concentrating of the surface active functionalities at the surface of the coating and facilitating formation of a superior surface interface to form during the cure process. Polyester-based polyfluorooxetane surface coating incorporating the above crosslinker provide superior surface properties for achieving dry erase performance as compared to like coatings prepared using other melamine crosslinking agents. Such coatings exhibit improved durability and clarity, resistance to moisture degradation of the composite, resistance to fracture, cracking and yellowing of the coating. Additionally, the crosslinker as described above achieves lower temperature cure than comparative crosslinkers, thereby increasing the selection of available substrates for coating to provide dry erase surfaces.

The dry erase composites of the present invention may be provided in a format to be self-supporting at a location of use through, for example, use of a rigid substrate as a part of the composite. Alternatively, the composite may be configured in a manner for ready support in predetermined frames or suspension systems. Additionally, the composite may be adhered to a rigid surface by use of separately applied fastening devices or adhesives. In a preferred alternative embodiment, the dry erase composite is provided with a precoated adhesive, and most preferably a precoated pressure sensitive adhesive for convenient application to a surface.

### EXAMPLES

In order to more thoroughly describe the present invention, the following working examples are provided. In each of these examples, a multi-layer flexible composite composed of an embossed 6 mil thick flexible vinyl substrate, and a polyfluorooxetane dry-erasable surface layer was prepared. In Examples 1 and 2 representing the present invention, a microroughened second layer was interposed between the substrate and the dry-erasable coating, while in Comparative Examples A and B, the dry-erasable coating was applied directly to the substrate.

In Examples 1 and 2, a microroughened second layer in accordance with the present invention was applied to the substrate by the cure-induced surface wrinkling technique described above. In this process, the substrate was first gravure printed with a Durethane UV Low Gloss N urethane acrylate coating (available from PPG, Industries, Inc. of Pittsburgh, Pa.) at an applied coating weight of 21 grams per square meter. The coated substrate was then continuously passed at a line speed of 30 yards per minute through a treatment oven wherein hot air was applied to the surface of the coated substrate at a temperature of about 100 to about 140° F. The coating was then irradiated with UV light at about 254 nm wavelength (i.e. “germicidal lamps”) under a nitrogen atmosphere at an intensity of 1.97 watts/linear centimeter and a duration of about 3.9 seconds. Because of these curing conditions, only the surface of the coating was cured. The surface cured product was then irradiated with additional broadband UV light at 240-450 nm wavelength at an intensity of 120 watts/linear centimeter for about 13.8 seconds to complete the cure of the coating. When measured by a Gardner Gloss Meter, the surface gloss of the cured second layer was determined to be 2.6±0.1 at a 600 angle of incidence.

Application of Dry-Erasable Surface Coating

A. Preparation of Polyfluorooxetane Segments

The polyfluorooxetane dry-erasable surface layers used in all examples were prepared by the amine-curing of a cross-linkable polyester-based polyfluorooxetane copolymer. This copolymer, in turn, was prepared by forming polyfluorooxetane segments and then copolymerizing these segments with other polyester-forming ingredients. These polyfluorooxetane segments were prepared in the following manner:

A 10 L jacketed reaction vessel with a condenser, thermo-couple probe, and a mechanical stirrer was charged with anhydrous methylene chloride (2.8 L), and 1,4-butanediol (101.5 g, 1.13 moles). BF₃THF (47.96 g, 0.343 moles) was then added, and the mixture was stirred for 10 minutes. A solution of 3-(2,2,2-Trifluoroethoxymethyl)-3-Methyloxetane (3,896 g. 21.17 moles) in anhydrous methylene chloride (1.5 L) was then pumped into the vessel over 5 hours. The reaction temperature was maintained between 38 and 42° C. throughout the addition. The mixture was then stirred at reflux for an additional 2 hours, after which ‘H NMR indicated >98% conversion. The reaction was quenched with 10% aqueous sodium bicarbonate (1 L), and the organic phase was washed with 3% aqueous HCI (4 L) and with water (4 L). The organic phase was dried over sodium sulfate, filtered, and stripped of solvent under reduced pressure to give 3,646 g (91.2%) of title glycol, a clear oil. NMR: The degree of polymerization (DP) as determined by TFAA analysis was 15.2 which translates to an equivalent weight of 2804. The THF content of this glycol, as determined by 1 H NMR, was 2.5% wt tetrahydrofuran (THF) (6.2% mole THF). This residual THF is a part of the catalyst and is incorporated at about 2.6 weight percent in the final product and cuts down on cyclic structure, thus the final fluorinated diol is a THF-FOX copolymer.

B. Preparation of the Crosslinkable Polyester-Based Polyfluorooxetanes

The polyfluorooxetane segments produced as described above were reacted with at least a two equivalent excess (generally 2.05-2.10 excess) of adipic acid in a reactor at 455° F. for 3.5 hours to form a polyoxetane having the half ester of adipic acid as end groups. NMR analysis was used to confirm that substantially all the hydroxyl groups were converted to the ester groups. The contents were cooled to room temperature (approximately 70° F.).

A second reactor was heated to 420° F. and 24.2 parts by weight adipic acid, 24.5 parts by weight phthalic anhydride, 20.5 parts by weight of cyclohexanedimethanol, 14.8 parts by weight of neopentyl glycol, 16.0 parts by weight of trimethylol propane and two weight percent of the above adipic acid functionalized polyoxetane/THF product was added to the reactor. The temperature was maintained for about 3 hours to polymerize these reactants; thereby producing hydroxyl-terminated polyesters.

C. Preparation of Dry-Erasable Surface Layers

In each example and comparative example, 33.84 wt. % of the crosslinkable polyester-based polyfluorooxetane copolymer produced as described above was combined with 40.17 wt. % of a melamine formaldehyde resin crosslinking agent, Solvent: 18.43 wt. % n-propyl acetate (solvent), 1.84 wt. % tetrahydrofuran and 5.72 wt. % of a crosslinking catalyst comprising 40% paratoluene sulfonic acid in isopropanol. In Example 1 and Comparative Example A, the melamine formaldehyde resin crosslinking agent was a liquid hexamethoxymethyl melamine (“HMMM”). In Example 2 and Comparative Example B, the liquid melamine formaldehyde resin crosslinking agent was a co-etherified reaction product of melamine with methanol and n-butanol in which the methanol/butanol molar ratio was 90:10, the average degree of polymerization was believed to be about 1 and the equivalent weight was believed to be about 74. In all examples, all of the ingredients except the catalyst were combined and mixed together, after which the catalyst was added and the composition stirred for a few more minutes. The composition was then applied to the substrates via wire rods at a nominal wet thickness of 1 to 2 mils and then cured by contact with heated air at 127° C. for 2 minutes.

The multilayer products obtained were then tested for surface gloss at incidence angles of 20°, 60°, and 85° angles using a Gardner Gloss Meter. In addition, the products were tested for durability using a durability test which measures the number of cycles a product can be marked with a commercially available dry erase marker (Expo Bold Chisel-Tip) and the mark then erased before failure. In this test, a circular piece of the product is mounted on the face of a rotating support and rotated about its center. The marker and a dry-erasable marker are mounted with respect to the rotating support in such a way that rotation of the test piece caused the marker to mark a portion of the test piece followed by drying of the mark and finally the eraser erasing the mark each time the test piece is rotated one revolution. Each revolution of the 6 inch diameter disk takes about 1 minute to ensure drying of the mark before erasure. The test piece is observed periodically so that the marker can be replaced and the eraser cleaned as needed. In general, the test is continued until the ink in the marker path fails to be erased. The results obtained are set forth in the following Table 1:

TABLE 1
Examples

| | Example 1 | Comp. Ex. A | Example 2 | Comp. Ex. B |
|---|---|---|---|---|
| Second layer | yes | no | yes | no |
| Amine crosslinker | HMMM | HMMM | C₁/C₄ | C₁/C₄ co-ether |
| | | | co-ether | |
| 20° Gloss | 5.2 ± 0.4 | 60.2 ± 0.8 | 4.1 ± 0.4 | 57.8 ± 2.4 |
| 60° Gloss | 27.3 ± 0.9 | 95.8 ± 1.4 | 21.0 ± 1.8 | 95.4 ± 2.8 |
| 85° Gloss | 38.0 ± 1.0 | 82.6 ± 1.5 | 28.2 ± 1.1 | 84.5 ± 1.5 |
| Cycles to Failure | 7,000 | 7,950 | >10,000 | >10,000 |

From the foregoing, it can be seen that the multilayer products of Examples 1 and 2, which are made with a microroughened second layer in accordance with the present invention, exhibit substantially less gloss, measured at 20°, 60°, and 85° as compared with comparative products not having these second layers. In addition, it can also be seen that this beneficial result is realized regardless of the type of amine resin crosslinking agent that is used. In addition, the foregoing also shows that products made with the co-ether amine resin crosslinking agent, whether or not containing a second layer, exhibit substantially better durability as compared with similar product made with the conventional melamine formaldehyde resin crosslinker.

Thus, it is clear that the present invention represents a significant advance over currently available technology in that it can provide dry-erasable multilayer articles and other products having a surface gloss of about 40 or less, about 30 or less or even 20 or less when measured at an angle of incidence 60° by a Gardner Gloss Meter. Moreover, by using the preferred amine resin crosslinking agent, as further described above, it is possible to combine excellent dry-erase characteristics, low surface gloss, and high durability all in the same product.

All percentages and ratios used herein are weight percentages and ratios unless otherwise indicated. All publications, patents and patent documents cited are fully incorporated by reference herein, as though individually incorporated by reference. Numerous characteristics and advantages of the invention meant to be described by this document have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

1. A low-gloss dry-erasable multilayer composite comprising a first layer having a dry-erasable outer surface and a second layer having a microroughened surface.

2. The composite of claim 1, wherein the first layer is in direct physical contact with the microroughened surface of the second layer.

3. The composite of claim 1, wherein the first layer is transparent.

4. The composite of claim 1, wherein the first layer is translucent.

5. The composite of claim 1, further comprising a substrate layer on the opposite side of the second layer from the first layer.

6. The composite of claim 1, wherein the microroughened surface comprises a random distribution of ridges and valleys.

7. The composite of claim 1, wherein the microroughened surface is formed by cure-induced surface wrinkling.

8. The composite of claim 1, wherein the microroughened surface comprises an ordered pattern of positive features and/or negative features.

10. The composite of claim 1, wherein the microroughened surface comprises an ordered pattern of ridges and valleys.

11. The composite of claim 1, wherein the second layer is formed from acrylic monomers or oligomers, methacrylic monomers or oligomers, N-vinyl pyrrolidine, urethane acrylic oligomers and epoxy acrylate oligomers.

12. The composite of claim 1, wherein the second layer is formed from a radiation-crosslinkable polyurethane acrylate copolymer.

13. The composite of claim 1, wherein the first layer is formed from a coating comprising a fluoropolymer.

14. The composite of claim 1, wherein the first layer is a laminated sheet comprising a fluoropolymer.

15. The composite of claim 1, wherein the first layer is formed from a coating composition comprising a polymer comprising at least one pendant fluoroalkoxyalkyl functionality.

16. The composite of claim 1, wherein the first layer is formed from a coating composition comprising a polymer comprising pendant fluorine-containing functionality derived from a fluorooxetane.

17. The composite of claim 1, wherein the first layer is formed from a polyester-based polyfluorooxetane copolymer crosslinked with an amine resin crosslinking agent.

18. The composite of claim 17, wherein the amine resin crosslinking agent is a co-etherified melamine formaldehyde resin reaction product of melamine and at least two different C₁ to C₁₀ alcohols.

19. The composite of claim 17, wherein the amnine resin crosslinking agent is a co-etherified melarnine formaldehyde resin reaction product of melamine methanol and butanol.

20. The composite of claim 1, wherein the composite exhibits a surface gloss of about 40 or less when measured at an angle of incidence 60°.

21. The composite of claim 1, wherein the composite exhibits a surface gloss of about 25 or less when measured at an angle of incidence 60°.

22. The composite of claim 1, further comprising a layer of adhesive coated on the opposite side of the second layer from the first layer.

23. The composite of claim 5 further comprising a layer of adhesive coated on the substrate layer on the opposite side of the substrate layer from the second layer.

24. A process for making a low-gloss dry-erasable multilayer composite comprising a first layer and a second layer comprising the steps of:
a) imparting a microroughened surface to the second layer, and
b) applying a first layer to the second layer so that the resulting multilayer composite has a dry-erasable outer surface.

25. The process of claim 24, wherein the second layer being made from a radiation-curable material, and the microroughened surface is imparted by subjecting the second layer to a curing operation in which the second layer is irradiated under conditions to form microwrinkles in its uppermost surface.

26. The process of claim 24, wherein the uppermost surface of the second layer is partially cured in a first curing step thereby causing microwrinkles to form in this uppermost surface, and then the second layer is subjected to a second curing step in which the entire second layer is cured.

27. The process of claim 26 which curing in the first and second curing steps are accomplished by irradiation of the second layer with light at different wavelengths.

28. The process of claim 26 which curing in the first and second curing steps are accomplished by irradiation of the second layer with light at the same wavelengths but different intensities.

29. A composition for forming a dry-erasable surface layer comprising a polyester-based polyfluorooxetane crosslinked with an amine resin crosslinking agent in which the amine resin crosslinking agent is a co-etherified melamine formaldehyde resin reaction product of melamine and at least two different C₁ to C₁₀ alcohols.

30. The composition of claim 30, wherein the amine resin crosslinking agent is a co-etherified melamine formaldehyde resin reaction product of melamine methanol and butanol.
